(19) United States
(12) Patent Application Publication
(10) Pub. No.: US 2026/0285431 A1
(43) Pub. Date: Sep. 24, 2026

(54) BICYCLE SEATPOST ASSEMBLY WITH SHOCK-ABSORBING FUNCTIONALITY

(71) Applicant: J.D COMPONENTS CO., LTD., CHANG HUA HSIEN (TW)

(72) Inventors: PIN-CHIEH FENG, CHANG HUA HSIEN (TW); YU-AN LIN, CHANG HUA HSIEN (TW); PO-HSUN CHEN, CHANG HUA HSIEN (TW)

(21) Appl. No.: 19/542,086

(22) Filed: Feb. 17, 2026

(30) Foreign Application Priority Data
Mar. 24, 2025 (TW) 114202878

(51) Int. Cl. B62J 1/00; B62J 1/02; B62J 1/04; B62J 1/08; B62K 19/36

(52) U.S. Cl. CPC B62J 1/007; B62J 1/00; B62J 1/02; B62J 1/04; B62K 19/36; B62J 2001/085

(57) ABSTRACT

A bicycle seatpost assembly includes a seatpost unit, a cushion adjusting unit, and a cushioning element. The cushion adjusting unit is detachably disposed at a top portion of the seatpost unit and includes a fixing base, at least one positioning member, an adjustment rod, and a guide block. The positioning member abuts against the fixing base and the seatpost unit. The adjustment rod is movable relative to the fixing base to drive the guide block to move upwardly and downwardly, and the cushioning element abuts against the guide block. Accordingly, preload of the cushioning element is adjustable via the adjustment rod, and the cushion adjusting unit can be assembled and disassembled from the top of the seatpost unit to facilitate maintenance.

### BACKGROUND OF THE INVENTION

### 1. Field of the Invention

The present invention relates to a bicycle seatpost and more particularly, to a bicycle seatpost assembly with shock-absorbing functionality, in which a cushion adjusting unit is provided to allow convenient adjustment of a preload of a cushioning element, so as to accommodate various riding requirements.

### 2. Description of the Related Art

During bicycle riding, in order to prevent discomfort to a rider when traveling over uneven road surfaces, a cushioning device is typically provided between the saddle and the seatpost to absorb vibrations and achieve a shock-absorbing effect. Most existing bicycle seatposts adopt pneumatic or hydraulic structures as the cushioning device. Such designs not only increase structural complexity, but also lead to difficulties in maintenance and repair.

Accordingly, some bicycle seatposts replace pneumatic or hydraulic structures with a cushioning structure made of rubber, polyurethane elastomer, or other elastic materials, so as to reduce vibrations transmitted to the saddle. Taiwan Patent No. M636793 discloses an improved shock-absorbing seatpost in which a cushioning assembly is disposed within an inner tube and includes a first sleeve, a second sleeve, and a cushioning structure. A slotted hole is formed in the first sleeve, allowing a fixing rod to pass through an aperture of the inner tube and extend into the slotted hole to fix a first fixing portion of the first sleeve. A rider may use a tool to rotate a threaded rod of the first sleeve, so that the threaded rod compresses or releases the cushioning structure, thereby adjusting the shock-absorbing effect.

However, such cushioning structures generally have a fixed elastic coefficient after manufacture, and thus cannot satisfy the needs of riders with different body types or adapt to various road conditions. Therefore, the prior patent proposes a mechanism for adjusting the cushioning structure by changing the position of the threaded rod within the inner tube to adjust the preload of the cushioning structure. Nevertheless, in order to prevent components below the threaded rod from rotating together with the threaded rod and causing idle rotation, the fixing rod is used to restrain the first fixing portion to avoid rotation of the first fixing portion. However, to install the fixing rod, it requires altering the original structure of the inner tube, thereby reducing the structural strength of the seatpost. Moreover, when disassembling the cushioning assembly disposed in the inner tube, operation must be performed from the bottom of the entire seatpost, and other components inside the seatpost must first be removed, resulting in a structure that is unfavorable for assembly and maintenance.

Accordingly, providing a bicycle seatpost capable of adjusting cushioning performance while also facilitating maintenance and repair has become an issue to be solved in the industry.

### SUMMARY OF THE INVENTION

In view of the foregoing, an objective of the present invention is to provide a bicycle seatpost assembly with shock-absorbing functionality. By improving the structural design of the cushion adjusting unit, assembly and disassembly operations can be made more convenient, while allowing a user to adjust the preload of the cushioning element.

To achieve the above-mentioned objective, the present invention provides a bicycle seatpost assembly comprising a seatpost unit, a cushion adjusting unit, and a cushioning element. The seatpost unit has a hollow structure and has an opening at a top end thereof. The cushion adjusting unit is inserted into the seatpost unit through the opening of the seatpost unit and detachably disposed at a top portion of the seatpost unit. The cushion adjusting unit comprises a fixing base, at least one positioning member, an adjustment rod, and a guide block. The adjustment rod is disposed inside the fixing base, the at least one positioning member is abutted against an outer peripheral surface of the fixing base and an inner peripheral surface of the seatpost unit, a first side of the guide block is abutted against a bottom end of the adjustment rod, and the adjustment rod is movable relative to the fixing base so as to drive the guide block to move upwardly and downwardly. The cushioning element is abutted against a second side of the guide block of the cushion adjusting unit.

By virtue of the above technical features, a user can directly perform maintenance on the cushion adjusting unit through the opening at the top end of the seatpost unit, thereby providing a structure that is highly convenient for assembly or maintenance. In addition, the user can operate the adjustment rod to move the adjustment rod relative to the fixing base, thereby driving the guide block to compress or release the cushioning element so as to adjust preload of the cushioning element. Since the positioning member is disposed between the fixing base and the seatpost unit, the fixing base and the seatpost unit are fixed relative to each other, such that the position of the fixing base is restricted. Accordingly, during operation of the adjustment rod, the fixing base does not move with the adjustment rod, and only the adjustment rod moves relative to the fixing base to push the guide block. Such a cushion adjusting unit avoids damaging the structure of the seatpost unit, eliminates the need for machining the seatpost unit, and maintains structural strength of the seatpost unit.

Preferably, the seatpost unit may comprise an outer tube, an inner tube disposed inside the outer tube, and a mount disposed at a top end of the outer tube. The cushion adjusting unit and the cushioning element are disposed inside the outer tube and the mount. Accordingly, the cushion adjusting unit can be installed without altering the structures of the outer tube and the mount. Such a non-drilled seatpost unit can retain original structural strength of the outer tube and the mount, and also provide good waterproof performance.

Preferably, the outer peripheral surface of the fixing base of the cushion adjusting unit is recessed to form at least one positioning groove in a way that the at least one positioning member is engaged with the fixing base through the at least one positioning groove. Accordingly, the positioning member can be stably disposed on the outer peripheral surface of the fixing base, which enhances assembly convenience and prevents displacement of the positioning member within the seatpost unit.

Preferably, the fixing base of the cushion adjusting unit includes an inner peripheral surface formed with an internal thread, and the adjustment rod includes an outer periphery surface formed with an external thread engaged with the internal thread of the fixing base, such that the adjustment rod is rotatable relative to the fixing base to generate upward and downward movement. Accordingly, the fixing base and the adjustment rod cooperate through threaded engagement to produce motion, enabling gradual adjustment of a stroke of the adjustment rod as required, so that the cushioning element can achieve an optimal preload.

Preferably, a top end of the adjustment rod of the cushion adjusting unit forms an operating portion having a hexagonal shaped recess. Accordingly, a user can engage a hexagonal wrench with the operating portion to rotate the adjustment rod, thereby providing a structure that is convenient for user operation.

Preferably, the adjustment rod of the cushion adjusting unit may be inwardly recessed from a bottom end thereof to form a latching portion, the guide block may have an inner annular wall and an outer annular wall surrounding around the inner annular wall, and the inner annular wall extends into and is engaged with the latching portion of the adjustment rod in a way that the bottom end of the adjustment rod is abutted against a region between the inner annular wall and the outer annular wall. Accordingly, the guide block is more stably coupled to the adjustment rod, and can move linearly when being driven, thereby making results of each preload adjustment of the cushioning element more consistent.

Preferably, the cushion adjusting unit may comprise a first sealing ring and a second sealing ring. The first sealing ring is disposed on the outer peripheral surface of a top portion of the fixing base and abutted against the inner peripheral surface of the seatpost unit. The second sealing ring is disposed on an outer peripheral surface of a top portion of the adjustment rod and abutted against an inner peripheral surface of the fixing base. Accordingly, the first sealing ring provides good waterproof performance between the cushion adjusting unit and the seatpost unit, and the second sealing ring provides good waterproof performance for the cushion adjusting unit itself, thereby preventing corrosion of components inside the seatpost unit.

Preferably, the cushion adjusting unit may comprise a cover body having a working hole extending through a top surface and a bottom surface thereof. The cover body is disposed at the top portion of the seatpost unit and covers top ends of the fixing base and the adjustment rod. Accordingly, the cover body can prevent external contaminants or moisture from entering the interior of the seatpost unit, thereby reducing the likelihood of damage to the cushion adjusting unit.

Preferably, the cushion adjusting unit may comprise a base disposed at an end of the cushioning element that is not abutted against the guide block. Accordingly, the base and the guide block cooperatively clamp the cushioning element, such that one end of the cushioning element can be compressed or released using the base as a support, thereby improving operational stability of the cushioning element.

Preferably, the cushioning element may be selected from a rubber block, a polyurethane elastomer block, or a spring. Accordingly, the cushioning element provides shock absorption with a simple structure, thereby improving riding comfort for a user.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of the present invention;

FIG. 2 is an exploded perspective view of the present invention;

FIG. 3 is a perspective view of a cushion adjusting unit of the present invention, in which a base is omitted;

FIG. 4 is an exploded perspective view of the cushion adjusting unit of the present invention, in which the base is omitted;

FIG. 5 is a partially enlarged cross-sectional view of the present invention; and

FIG. 6 is a cross-sectional view of the present invention, illustrating a state in which a cushioning element is compressed.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

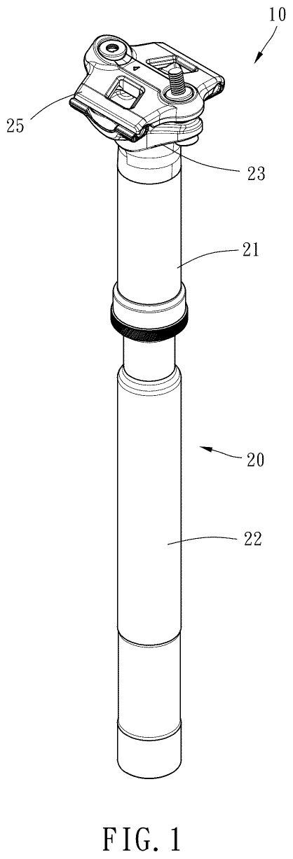

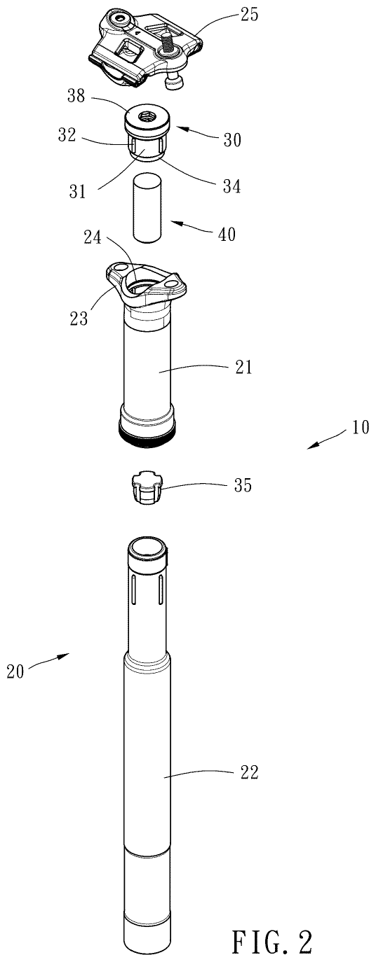

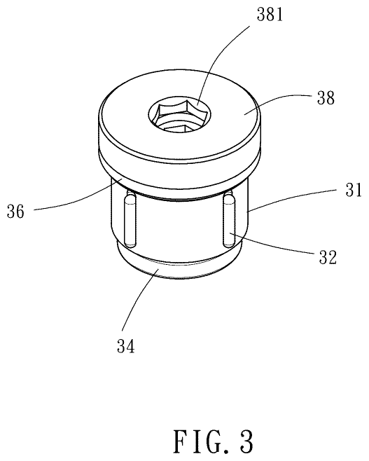

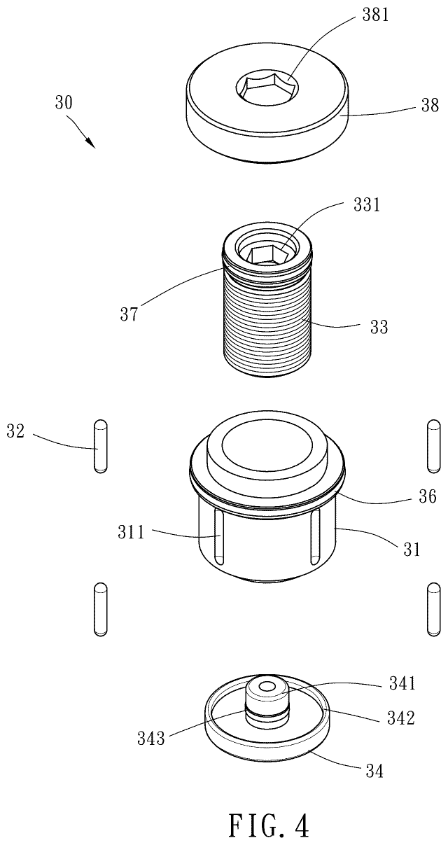

Referring to FIGS. 1 to 4, a bicycle seatpost assembly 10 with shock-absorbing functionality according to the present invention mainly comprises a seatpost unit 20, a cushion adjusting unit 30, and a cushioning element 40.

The seatpost unit 20 has a hollow structure and comprises an outer tube 21, an inner tube 22, and a mount 23. The outer tube 21 is sleeved onto the inner tube 22, and a lifting valve assembly may be installed in the inner tube 22. The mount 23 is disposed at a top end of the outer tube 21, and a top end of the mount 23 defines an opening 24, which communicates with an interior of the outer tube 21. A saddle rail mounting member 25 is further assembled on the mount 23 for mounting saddle rails of a saddle. In another embodiment, the mount 23 may be integrally formed at the top end of the outer tube 21, such that the mount 23 and the outer tube 21 constitute a one-piece structure. When the cushion adjusting unit 30 and the cushioning element 40 are installed, they are inserted into the seatpost unit 20 through the opening 24 and positioned at a top portion of the seatpost unit 20, namely inside the mount 23 and the outer tube 21. Likewise, when disassembling the cushion adjusting unit 30 and the cushioning element 40, the user can remove them through the opening 24 of the seatpost unit 20.

The cushion adjusting unit 30 includes a fixing base 31, four positioning members 32, an adjustment rod 33, and a guide block 34. An inner peripheral surface of the fixing base 31 is formed with an internal thread, and an outer peripheral surface thereof is recessed to form four positioning grooves 311 arranged at equal intervals. The positioning members 32 may be, for example, elongated pin members, and are respectively engaged with the four positioning grooves 311 of the fixing base 31. An outer peripheral surface of the adjustment rod 33 is formed with an external thread, a top end of the adjustment rod 33 forms an operating portion 331 having a hexagonal shaped recess, and a bottom end thereof forms a latching portion 332. The latching portion 332 is formed by inwardly recessing a central region of the bottom end of the adjustment rod 33 to define a cylindrical hole, and an annular latching groove is further formed around the cylindrical hole. The guide block 34 is an annular plate body, in which an inner annular wall 341 extends upwardly from a periphery of a central circular opening, and an outer annular wall 342 extends upwardly from an outer edge of the guide block 34. The inner annular wall 341 has a height greater than that of the outer annular wall 342, and an annular protrusion 343 protrudes outwardly from an outer peripheral surface of the inner annular wall 341.

In this embodiment, the fixing base 31 is formed with four positioning grooves 311 and cooperates with four positioning members 32. When the cushion adjusting unit 30 is installed into the seatpost unit 20, the four positioning members 32 allow the fixing base 31 to be tightly coupled to the inner peripheral surface of the seatpost unit 20, such that the fixing base 31 achieves optimal anti-rotation and anti-displacement effects. However, an arrangement using only one positioning groove 311 in combination with one positioning member 32 is also capable of restricting the position of the fixing base 31, although such an arrangement is more likely to cause uneven force distribution on the fixing base 31.

When the cushion adjusting unit 30 is assembled, the adjustment rod 33 is inserted into the fixing base 31, and the external thread of the adjustment rod 33 is engaged with the internal thread of the fixing base 31. The inner annular wall 341 of the guide block 34 is then inserted into the latching portion 332 of the adjustment rod 33, such that the annular protrusion 343 of the inner annular wall 341 is engaged with the annular latching groove of the latching portion 332, thereby coupling the guide block 34 to the adjustment rod 33 in a linked manner. At this time, the bottom end of the adjustment rod 33 abuts against a first side of the guide block 34. Specifically speaking, the bottom end of the adjustment rod 33 abuts against a region between the inner annular wall 341 and the outer annular wall 342 of the guide block 34. According to movement of the adjustment rod 33 within the fixing base 31, the guide block 34 is driven to move upwardly and downwardly. When the bottom end of the adjustment rod 33 is flush with a bottom end of the fixing base 31, the bottom end of the fixing base 31 also abuts against the region between the inner annular wall 341 and the outer annular wall 342 of the guide block 34. Since the fixing base 31 is restricted from movement by the positioning members 32, this position serves as an initial operating position of the adjustment rod 33.

One end of the cushioning element 40 abuts against a second side of the guide block 34 that does not abut against the adjustment rod 33, and the other end thereof may directly abut against a top end of the inner tube 22 or abut against a base 35. The base 35 is inserted into and fixed at the top end of the inner tube 22, such that the end of the cushioning element 40 that does not abut against the guide block 34 can abut against a top surface of the base 35, whereby the cushioning element 40 is positioned within the seatpost unit 20.

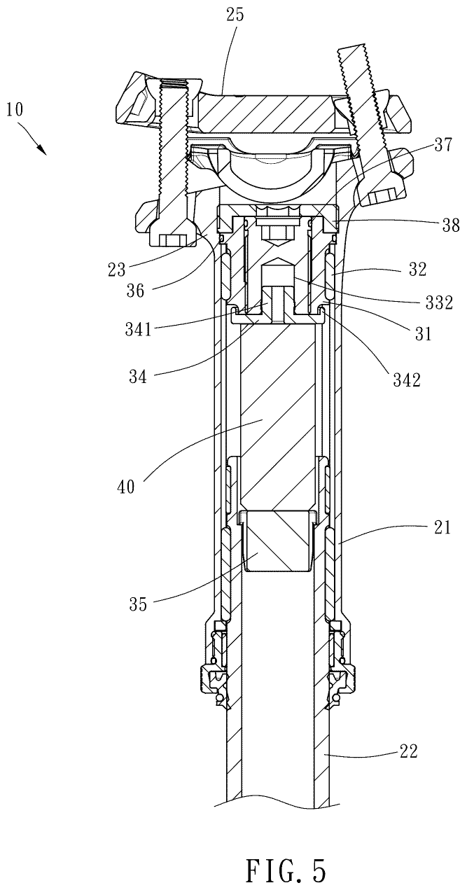

Referring further to FIG. 5, in order to enhance durability of the bicycle seatpost assembly 10, the cushion adjusting unit 30 further includes a first sealing ring 36, a second sealing ring 37, and a cover body 38. The first sealing ring 36 and the second sealing ring 37 are O-rings. The first sealing ring 36 is disposed between the fixing base 31 and the seatpost unit 20, and is fitted onto an outer peripheral surface of a top portion of the fixing base 31 while abutting against an inner peripheral surface of the seatpost unit 20. Accordingly, the first sealing ring 36 tightly seals a gap between the fixing base 31 and the seatpost unit 20. The second sealing ring 37 is disposed between the fixing base 31 and the adjustment rod 33, and is fitted onto an outer peripheral surface of a top portion of the adjustment rod 33 while abutting against an inner peripheral surface of the fixing base 31. Accordingly, the second sealing ring 37 tightly seals a gap between the fixing base 31 and the adjustment rod 33. By virtue of the arrangement of the first sealing ring 36 and the second sealing ring 37, external water is prevented from flowing into interiors of the fixing base 31 and the adjustment rod 33, thereby providing good waterproof performance for the bicycle seatpost assembly 10.

The cover body 38 has an inverted U-shaped configuration, and a hexagonal working hole 381 is formed at a central position thereof. The working hole 381 extends through a top surface and a bottom surface of the cover body 38. An outer peripheral surface of the cover body 38 is optionally formed with external threads, and an inner peripheral surface of the mount 23 of the seatpost unit 20 may be correspondingly formed with internal threads, such that the cover body 38 can be threaded into the mount 23 through the opening 24 of the seatpost unit 20. When the cover body 38 is installed within the seatpost unit 20, the cover body 38 is located above the fixing base 31 and the adjustment rod 33 so as to cover top ends of the fixing base 31 and the adjustment rod 33, thereby reducing chances of external dirt or moisture entering the cushion adjusting unit 30 and achieving dustproof and waterproof effects. In addition, the cover body 38 is also capable of fixing positions of the fixing base 31 and the adjustment rod 33, so that the fixing base 31 and the adjustment rod 33 are not easily disengaged from the opening 24 of the seatpost unit 20.

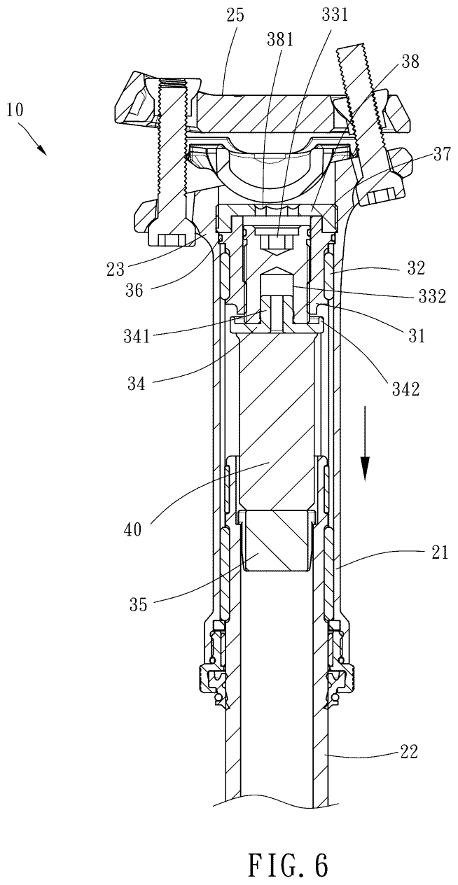

Referring further to FIG. 6, during actual operation, since the working hole 381 of the cover body 38 communicates with the operating portion 331 of the adjustment rod 33, and a size of the working hole 381 is larger than that of the operating portion 331, a user is able to insert a hex wrench through the working hole 381 of the cover body 38 and engage the operating portion 331 of the adjustment rod 33, so as to rotate the adjustment rod 33.

When it is desired to increase a preload of the cushioning element 40, the user rotates the adjustment rod 33 clockwise by means of the hex wrench. Since the fixing base 31 is restricted by the positioning member 32 and is prevented from rotating, the adjustment rod 33 is displaced downwardly relative to the fixing base 31, and the guide block 34 is correspondingly displaced downwardly with movement of the adjustment rod 33. Accordingly, the adjustment rod 33 and the guide block 34 push against the cushioning element 40, and the cushioning element 40 is compressed with an end thereof abutting against the base 35 as a support, thereby increasing the preload of the cushioning element 40. Conversely, when the user rotates the adjustment rod 33 counterclockwise such that the adjustment rod 33 is displaced upwardly relative to the fixing base 31, the guide block 34 is displaced upwardly with movement of the adjustment rod 33. At this time, a pushing force applied by the adjustment rod 33 and the guide block 34 to the cushioning element 40 is reduced, and the cushioning element 40 elastically rebounds by virtue of its own restoring force, thereby decreasing the preload of the cushioning element 40.

In summary, as compared with the prior art, the bicycle seatpost assembly 10 with shock-absorbing functionality provided by the present invention has at least the following advantages:
1. In the bicycle seatpost assembly 10 of the present invention, the adjustment rod 33 of the cushion adjusting unit 30 is movable relative to the fixing base 31, such that the guide block 34 abutted against the adjustment rod 33 is driven accordingly to compress or release the cushioning element 40, thereby achieving adjustment of a preload of the cushioning element 40. Accordingly, the bicycle seatpost assembly 10 is more adaptable to riders of different body types as well as to various riding conditions.
2. In the bicycle seatpost assembly 10 of the present invention, the positioning member 32 of the cushion adjusting unit 30 is disposed between the fixing base 31 and the seatpost unit 20, and the positioning member 32 simultaneously abuts against the fixing base 31 and the seatpost unit 20, such that the fixing base 31 is engaged and fixed relative to the seatpost unit 20. Since the seatpost unit 20 itself is a stationary tubular structure, the fixing base 31 is thereby restricted from rotation and displacement. This design does not require damaging or modifying the structure of the seatpost unit 20, and thus allows the original structural strength of the seatpost unit 20 to be maintained.
3. In the bicycle seatpost assembly 10 of the present invention, the cushion adjusting unit 30 and the cushioning element 40 are installed or removed through the opening 24 at the top end of the seatpost unit 20, without the need to first remove other components from inside the seatpost unit 20 in order to access the cushion adjusting unit 30. Accordingly, the bicycle seatpost assembly 10 provides a structure that is convenient for assembly, maintenance, and servicing.

Finally, it should be noted that the constituent elements disclosed in the above embodiments of the present invention are only taken as examples for illustration, not intended to limit the scope of the present invention. The substitution or variation of other equivalent elements should be included within the scope of the following claims of the present invention.

What is claimed is:

1. A bicycle seatpost assembly, comprising:
a seatpost unit having a hollow structure and having an opening at a top end thereof;
a cushion adjusting unit inserted into the seatpost unit through the opening of the seatpost unit and detachably disposed at a top portion of the seatpost unit, the cushion adjusting unit comprising a fixing base, at least one positioning member, an adjustment rod, and a guide block; wherein the adjustment rod is disposed inside the fixing base, the at least one positioning member is abutted against an outer peripheral surface of the fixing base and an inner peripheral surface of the seatpost unit, a first side of the guide block is abutted against a bottom end of the adjustment rod, and the adjustment rod is movable relative to the fixing base so as to drive the guide block to move upwardly and downwardly; and
a cushioning element abutted against a second side of the guide block of the cushion adjusting unit.

2. The bicycle seatpost assembly as claimed in claim 1, wherein the seatpost unit comprises an outer tube, an inner tube disposed inside the outer tube, and a mount disposed at a top end of the outer tube, and the cushion adjusting unit and the cushioning element are disposed inside the outer tube and the mount.

3. The bicycle seatpost assembly as claimed in claim 1, wherein the outer peripheral surface of the fixing base of the cushion adjusting unit is recessed to form at least one positioning groove; the at least one positioning member is engaged with the fixing base through the at least one positioning groove.

4. The bicycle seatpost assembly as claimed in claim 1, wherein the fixing base of the cushion adjusting unit includes an inner peripheral surface formed with an internal thread; the adjustment rod includes an outer periphery surface formed with an external thread engaged with the internal thread of the fixing base, such that the adjustment rod is rotatable relative to the fixing base to generate upward and downward movement.

5. The bicycle seatpost assembly as claimed in claim 1, wherein a top end of the adjustment rod of the cushion adjusting unit forms an operating portion having a hexagonal shaped recess.

6. The bicycle seatpost assembly as claimed in claim 1, wherein the adjustment rod of the cushion adjusting unit is inwardly recessed from a bottom end thereof to form a latching portion; the guide block has an inner annular wall and an outer annular wall surrounding around the inner annular wall; the inner annular wall extends into and is engaged with the latching portion of the adjustment rod in a way that the bottom end of the adjustment rod is abutted against a region between the inner annular wall and the outer annular wall.

7. The bicycle seatpost assembly as claimed in claim 1, wherein the cushion adjusting unit comprises a first sealing ring and a second sealing ring; the first sealing ring is disposed on the outer peripheral surface of a top portion of the fixing base and abutted against the inner peripheral surface of the seatpost unit; the second sealing ring is disposed on an outer peripheral surface of a top portion of the adjustment rod and abutted against an inner peripheral surface of the fixing base.

8. The bicycle seatpost assembly as claimed in claim 1, wherein the cushion adjusting unit comprises a cover body having a working hole extending through a top surface and a bottom surface thereof; the cover body is disposed at the top portion of the seatpost unit and covers top ends of the fixing base and the adjustment rod.

9. The bicycle seatpost assembly as claimed in claim 1, wherein the cushion adjusting unit comprises a base disposed at an end of the cushioning element that is not abutted against the guide block.

10. The bicycle seatpost assembly as claimed in claim 1, wherein the cushioning element is selected from a rubber block, a polyurethane elastomer block, or a spring.
